(19) United States
(12) Patent Application Publication
(10) Pub. No.: US 2021/0243600 A1
(43) Pub. Date: Aug. 5, 2021

(54) Method, Device and System for Accessing Network Slice

(71) Applicant: ZTE Corporation, Shenzhen (CN)

(72) Inventor: Wantao YU, Shenzhen (CN)

(21) Appl. No.: 17/050,474

(22) PCT Filed: Apr. 26, 2019
(86) PCT No.: PCT/CN2019/084616

§ 371 Date: Oct. 26, 2020

(30) Foreign Application Priority Data
Apr. 26, 2018 (CN) 201810385821.X

(51) Int. Cl. H04W 12/06; H04W 12/08; H04W 12/033; H04W 12/72; H04W 12/75; H04W 8/18

(52) U.S. Cl. CPC H04W 12/06; H04W 12/08; H04W 8/18; H04W 12/72; H04W 12/75; H04W 12/033

(57) ABSTRACT

The embodiments of the disclosure disclose a method, device and system for accessing a network slice. The method includes that: User Equipment (UE) sends, to a base station, request information for accessing a network slice, wherein the request information contains user identity information and temporary network slice identity information (SliceIDₜ); a user subscription data management entity receives the request information from the UE through the base station, determines authentication information of the UE according to the user identity information contained in the request information, searches for corresponding network slice identity information (SliceID) according to the SliceIDₜ and sends the authentication information to a security management entity of the network slice corresponding to the SliceID; and the security management entity performs access authentication with the UE according to the authentication information, and in case of successful authentication, the UE accesses the network slice.

### TECHNICAL FIELD

The present application relates to the field of communication, and particularly to a method, device and system for accessing a network slice.

### BACKGROUND

Novel Information Technologies (IT), for example, Network Function Virtualization (NFV), will be introduced to a 5th-Generation (5G) network architecture. In a 3rd-Generation/4th-Generation (3G/4G) network, protection of a functional network element relies heavily on security isolation of a physical device. In a 5G network, deployment of the NFV technology enables deployment of part of functional network elements on a cloud infrastructure in the form of virtual functional network elements. A virtual core network constructed based on a network service requirement is called a network slice, and a network slice forms a virtual core network and provides mobile network access service for a group of specific User Equipment (UE). A typical network slice includes a set of virtualized core network functions including, for example, a slice control plane unit, a slice user plane unit, a slice policy control unit and a slice charging unit. The slice control plane unit is mainly responsible for functions related to mobility of slices, session management and authentication. The slice user plane unit is mainly responsible for providing a user resource of the slice for a user. The slice policy control unit is responsible for functions of user policies. The slice charging unit is responsible for a charging function for the user. A function of a network slice is determined by an operating company according to a requirement and a policy of the operating company. For example, some network slices may include dedicated forwarding planes in addition to control plane functions; and some network slices may only include some basic control plane functions, and other core network related functions may be achieved by sharing with other network slices. A network slice may be created, modified or deleted based on a requirement. A piece of UE may simultaneously receive services from different network slices.

In an existing 3G/4G mobile communication system, there are no network slices, so UE directly uses services provided by a core network after accessing the network through Authentication and Key Agreement (AKA) authentication. In a 5G system, the concept of network slice is introduced, so UE is required to further access a network slice after being attached to a network. When accessing a network slice, the UE is required to send slice identity information to the network, and the network determines the network slice accessed by the UE according to the slice identity information.

### SUMMARY

Embodiments of the disclosure provide a method, device and system for accessing a network slice, which may protect the privacy of network slice identity information under the condition of ensuring that UE accesses a network slice.

The embodiments of the disclosure provide a method for accessing a network slice, which may include that:

UE sends request information for accessing a network slice, wherein the request information contains user identity information and temporary network slice identity information (SliceIDₜ); and

the UE performs access authentication with the network slice, and in case of successful authentication, accesses the network slice.

The embodiments of the disclosure provide another method for accessing a network slice, which may include that:

a user subscription data management entity receives, from UE through a base station, request information for accessing a network slice, wherein the request information contains user identity information and temporary network slice identity information (SliceIDₜ); and

the user subscription data management entity determines authentication information of the UE according to the user identity information, searches for corresponding network slice identity information (SliceID) according to the SliceIDₜ and sends the authentication information to a security management entity of the network slice corresponding to the SliceID to enable the security management entity to perform authentication with the UE to implement access of the UE to the network slice.

The embodiments of the disclosure provide still another method for accessing a network slice, which may include that:

UE sends, to a base station, request information for accessing a network slice, wherein the request information contains user identity information and temporary network slice identity information (SliceIDₜ);

a user subscription data management entity receives the request information from the UE through the base station, determines authentication information of the UE according to the user identity information contained in the request information, searches for corresponding network slice identity information (SliceID) according to the SliceIDₜ and sends the authentication information to a security management entity of the network slice corresponding to the SliceID; and

the security management entity performs access authentication with the UE according to the authentication information, and in case of successful authentication, the UE accesses the network slice.

The embodiments of the disclosure also provide a device for accessing a network slice, which may include:

a first sending module, configured to send request information for accessing a network slice, wherein the request information contains user identity information and temporary network slice identity information (SliceIDₜ); and

a first authentication module, configured to perform access authentication with the network slice and, in case of successful authentication, access the network slice.

The embodiments of the disclosure provide another device for accessing a network slice, which may include:

a first receiving module, configured to receive, from UE through a base station, request information for accessing a network slice, wherein the request information contains user identity information and temporary network slice identity information (SliceIDₜ); and

a second sending module, configured to determine authentication information of the UE according to the user identity information, search for corresponding network slice identity information (SliceID) according to the SliceIDₜ and send the authentication information to a security management entity of the network slice corresponding to the SliceID to enable the security management entity to perform authentication with the UE to implement access of the UE to the network slice.

The embodiments of the disclosure also provide a system for accessing a network slice, which may include UE, a base station, a user subscription data management entity and a security management entity, wherein

the UE may be configured to send, to the base station, request information for accessing a network slice, wherein the request information contains user identity information and temporary network slice identity information (SliceIDₜ), perform access authentication with the security management entity and, in case of successful authentication, access the network slice;

the user subscription data management entity may be configured to receive the request information from the UE through the base station, determine authentication information of the UE according to the user identity information contained in the request information, search for corresponding network slice identity information (SliceID) according to the SliceIDₜ and send the authentication information to the security management entity of the network slice corresponding to the SliceID; and

the security management entity may be configured to perform access authentication with the UE according to the authentication information and, in case of successful authentication, allow the UE to access the network slice.

The embodiments of the disclosure also provide UE, which may include:

a processor;

a memory configured to store an instruction executable for the processor; and

a transmission device configured to perform information transmission and reception communication according to control of the processor,

wherein the processor may be configured to execute the following operations of:

sending request information for accessing a network slice, wherein the request information contains user identity information and temporary network slice identity information (SliceIDₜ); and

performing access authentication with the network slice, and in case of successful authentication, accessing the network slice.

The embodiments of the disclosure also provide a user subscription data management entity, which may include:

a processor;

a memory configured to store an instruction executable for the processor; and

a transmission device configured to perform information transmission and reception communication according to control of the processor,

wherein the processor may be configured to execute the following operations of:

receiving, from UE through a base station, request information for accessing a network slice, wherein the request information contains user identity information and temporary network slice identity information (SliceIDₜ); and

determining authentication information of the UE according to the user identity information, searching for corresponding network slice identity information (SliceID) according to the SliceIDₜ and sending the authentication information to a security management entity of the network slice corresponding to the SliceID to enable the security management entity to perform authentication with the UE to implement access of the UE to the network slice.

According to the embodiments of the disclosure, the UE sends, to the base station, request information for accessing a network slice, wherein the request information contains the user identity information and the temporary network slice identity information (SliceIDₜ); the user subscription data management entity receives the request information from the UE through the base station, determines the authentication information of the UE according to the user identity information contained in the request information, searches for the corresponding network slice identity information (SliceID) according to the SliceIDₜ and sends the authentication information to the security management entity of the network slice corresponding to the SliceID; and the security management entity performs access authentication with the UE according to the authentication information, and in case of successful authentication, the UE accesses the network slice. In the embodiments of the disclosure, transmission of plaintext network slice identity information during access of the UE to the network slice is avoided, so that the privacy and security of the network slice identity information are ensured.

Other characteristics and advantages of the disclosure will be elaborated in the following specification, and moreover, partially become apparent from the specification or be understood by implementing the disclosure. The objectives and other advantages of the disclosure may be achieved through structures specifically pointed out in the specification, the claims and the drawings.

### BRIEF DESCRIPTION OF THE DRAWINGS

The drawings provide a deeper understanding to the technical solution of the disclosure, form a part of the specification and are adopted to explain, together with the embodiments of the present application, the technical solutions of the disclosure and not intended to form limits to the technical solutions of the disclosure.

FIG. 1(a) and FIG. 1(b) are schematic diagrams of a network architecture according to an embodiment of the disclosure;

FIG. 2 is a flowchart of a method for accessing a network slice (applied to a system) according to an embodiment of the disclosure;

FIG. 3 is a flowchart of a method for accessing a network slice (applied to UE) according to an embodiment of the disclosure;

FIG. 4 is a flowchart of a method for accessing a network slice (applied to a user subscription data management entity) according to an embodiment of the disclosure;

FIG. 5 is a flowchart of a network slice attachment procedure according to an application example of the disclosure;

FIG. 6 is a flowchart of a network slice access procedure according to an application example of the disclosure;

FIG. 7 is a schematic diagram of a device for accessing a network slice (applied to UE) according to an embodiment of the disclosure; and

FIG. 8 is a schematic diagram of a device for accessing a network slice (applied to a user subscription data management entity) according to an embodiment of the disclosure.

### DETAILED DESCRIPTION OF THE EMBODIMENTS

The embodiments of the disclosure will be described below in combination with the drawings in detail. It is to be noted that the embodiments in the present application and characteristics in the embodiments may be freely combined if no conflict is caused.

The operations shown in the flowcharts of the drawings may be executed in a computer system capable of executing instructions, for example, a group of computer executable instructions. Moreover, although logic sequences are shown in the flowcharts, the shown or described operations may be executed in sequences different from those shown herein in some cases.

If UE directly sends network slice identity information through a plaintext when accessing a network slice, an attacker may collect information of a group of UE accessing the network slice and conduct service denial attacks on the group of UE accessing a certain network slice based on collected information of the group of UE. In addition, a network slice serving UE may dynamically change, and the UE may also need to simultaneously access different network slices to receive services.

In view of this, the embodiments of the disclosure provide a method, device and system for accessing a network slice, to achieve the effect of slice identity privacy and security protection during access of UE to a network slice in a 5G communication system.

FIG. 1(a) and FIG. 1(b) show a network architecture according to an embodiment of the disclosure.

On a network side, a user subscription data management entity of a home network, for example, an Authentication Server Function (AUSF), manages and maintains user subscription data. The AUSF may configure a piece of temporary network slice identity information (SliceIDₜ) for each subscriber, i.e., a user allowed to access a network slice. In addition, the AUSF is also a network entity configured to manage UE access authentication. The AUSF saves, manages and maintains a corresponding relationship list between network slice identity information (SliceID) and temporary network slice identity information (SliceIDₜ).

In the embodiment of the disclosure, the user subscription data at least includes user subscription identity information, i.e., an International Mobile Subscriber Identification Number (IMSI), the network slice identity information (SliceID) and the temporary network slice identity information (SliceIDₜ). The temporary network slice identity information (SliceIDₜ) is temporary identity information for a network slice.

In the embodiment of the disclosure, a piece of network slice identity information (SliceID) corresponds to a piece of temporary network slice identity information (SliceIDₜ).

On the network side, a network slice may include a security management entity such as a Security Anchor Function (SEAF), and the SEAF is a security anchor in the network slice.

The network slice may further include a mobility management entity, such as an Access and Mobility Management Function (AMF), for mobility management of UE. When the UE accesses the network slice, signaling is forwarded through the AMF.

On a terminal side, UE maintains and manages user subscription data. The UE saves, manages and maintains a corresponding relationship list between network slice identity information (SliceID) and temporary network slice identity information (SliceIDₜ). A piece of UE may access multiple different network slices, and in such case, a piece of UE may save, manage and maintain a corresponding relationship list between multiple pieces of different network slice identity information (SliceID) and corresponding temporary network slice identity information (SliceIDₜ).

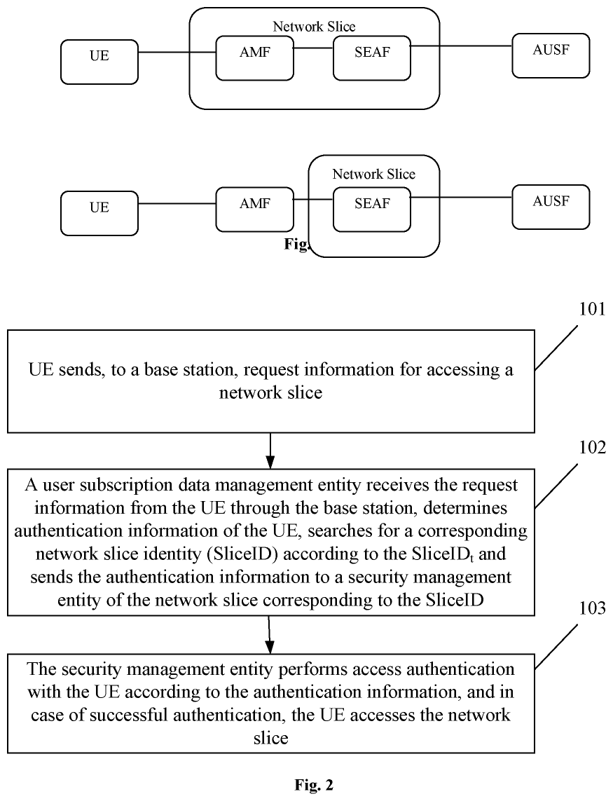

As shown in FIG. 2, a method for accessing a network slice of the embodiments of the disclosure includes the following operations.

In operation 101, UE sends, to a base station, request information for accessing a network slice, wherein the request information contains user identity information and temporary network slice identity information (SliceIDₜ).

The base station may be a 5G base station, i.e., a gNB. The request information may be attachment request information sent when the UE accesses a network, and may also be network slice access request information sent for a certain network slice after the UE accesses the network.

The user identity information may be temporary user subscription identity information such as a Temporary Mobile Subscriber Identifier (TMSI), and may also be encrypted user subscription identity information such as a Subscription Concealed Identifier (SUCI).

In the embodiments of the disclosure, a slice access process for a subscriber is proposed. A piece of temporary slice identity information SliceIDₜ may be allocated for UE. After the access process is ended, the temporary slice identity information that has been used is deleted, and new temporary network slice information is allocated for the UE when the UE accesses a slice next time.

In operation 102, a user subscription data management entity receives the request information from the UE through the base station, determines authentication information of the UE according to the user identity information contained in the request information, searches for corresponding network slice identity information (SliceID) according to the SliceIDₜ and sends the authentication information to a security management entity of the network slice corresponding to the SliceID.

The user subscription data management entity may include an AUSF, and the security management entity may include an SEAF.

In the operation, there are two situations.

In a first situation, the request information is attachment request information.

In this situation, the authentication information includes one or more authentication vectors, and the user subscription data management entity determines the user subscription identity information (IMSI) according to the user identity information, generates a set of corresponding authentication vectors according to the user subscription identity information and sends the set of authentication vectors to the security management entity of the network slice corresponding to the SliceID.

In a second situation, the request information is network slice access request information.

In this situation, since the security management entity usually saves an authentication vector corresponding to user subscription identity information, it is only required that the authentication information includes the user subscription identity information and the network slice access request information.

The user subscription data management entity determines the user subscription identity information according to the user identity information and sends the user subscription identity information and the network slice access request information to the security management entity of the network slice corresponding to the SliceID.

In operation 103, the security management entity performs access authentication with the UE according to the authentication information, and in case of successful authentication, the UE accesses the network slice.

In an embodiment, if the authentication information includes the set of authentication vectors, the security management entity selects one authentication vector from the received set of authentication vectors and performs AKA authentication with the UE according to the selected authentication vector.

In an embodiment, if the authentication information includes the user subscription identity information and the network slice access request information, the security management entity selects one authentication vector from a set of authentication vectors corresponding to the user subscription identity information and performs AKA authentication with the UE according to the selected authentication vector.

If the security management entity determines that all the authentication vectors corresponding to the user subscription identity information have been used, authentication request information is sent to the user subscription data management entity. The user subscription data management entity generates a set of authentication vectors according to the user subscription identity information and sends the set of generated authentication vectors to the security management entity. The security management entity selects one authentication vector from the set of authentication vectors and performs AKA authentication with the UE according to the selected authentication vector.

In the embodiments of the disclosure, transmission of plaintext network slice identity information during access of the UE to the network slice is avoided, so that the privacy and security of the network slice identity information are ensured.

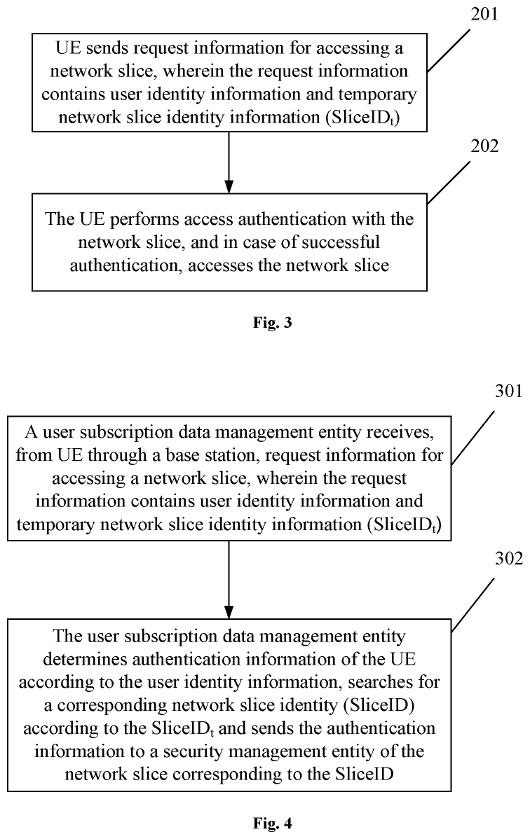

For UE in the embodiments of the disclosure, as shown in FIG. 3, a method for accessing a network slice includes the following operations.

In operation 201, the UE sends request information for accessing a network slice, wherein the request information contains user identity information and temporary network slice identity information (SliceIDₜ).

In the operation, the UE sends the request information to a base station (for example, a 5G base station, i.e., a gNB).

The request information may include at least one of attachment request information, and network slice access request information.

The user identity information may include at least one of temporary user subscription identity information (for example, a TMSI), and encrypted user subscription identity information (for example, an SUCI).

In operation 202, the UE performs access authentication with the network slice, and in case of successful authentication, accesses the network slice.

The UE performs access authentication with a security management entity in the network slice, and the access authentication may be AKA authentication.

In an embodiment, the method further includes that: the UE saves and maintains a corresponding relationship list between network slice identity information (SliceID) and SliceIDₜ, wherein the SliceIDₜ is in one-to-one correspondence with the SliceID.

In an embodiment, the UE may obtain the SliceIDₜ through a user subscription data management entity, and may also generate the SliceIDₜ according to the SliceID through a preset generation rule.

In the embodiments of the disclosure, transmission of plaintext network slice identity information during access of the UE to the network slice is avoided, so that the privacy and security of the network slice identity information are ensured.

For a user subscription data management entity in the embodiments of the disclosure, as shown in FIG. 4, a method for accessing a network slice includes the following operations.

In operation 301, the user subscription data management entity receives, from UE through a base station, request information for accessing a network slice, wherein the request information contains user identity information and temporary network slice identity information (SliceIDₜ).

The user subscription data management entity may include an AUSF, and a security management entity may include an SEAF.

The request information may include at least one of attachment request information, and network slice access request information.

The user identity information may include at least one of temporary user subscription identity information (for example, a TMSI), and encrypted user subscription identity information (for example, an SUCI).

In operation 302, the user subscription data management entity determines authentication information of the UE according to the user identity information, searches for corresponding network slice identity information (SliceID) according to the SliceIDₜ and sends the authentication information to a security management entity of the network slice corresponding to the SliceID to enable the security management entity to perform authentication with the UE to implement access of the UE to the network slice.

In an embodiment, the request information for accessing the network slice may be attachment request information, and the authentication information may include one or more authentication vectors. The operation that the user subscription data management entity determines the authentication information of the UE according to the user identity information includes that: the user subscription data management entity determines user subscription identity information according to the user identity information and generates a set of corresponding authentication vectors according to the user subscription identity information.

The authentication vector is configured for access authentication between the security management entity and the UE.

In an embodiment, the request information for accessing the network slice includes network slice access request information, and the authentication information includes the user subscription identity information and the network slice access request information. The operation that the user subscription data management entity determines the authentication information of the UE according to the user identity information includes that: the user subscription data management entity determines the user subscription identity information according to the user identity information.

In an embodiment, if the security management entity determines that all authentication vectors corresponding to the user subscription identity information have been used, the method may further include that:

the user subscription data management entity receives authentication request information sent by the security management entity, wherein the authentication request information contains the user subscription identity information; and

the user subscription data management entity generates a set of authentication vectors according to the user subscription identity information and sends the set of generated authentication vectors to the security management entity.

In an embodiment, the method further includes that: the user subscription data management entity generates a SliceIDₜ corresponding to the SliceID, wherein the SliceIDₜ is in one-to-one correspondence with the SliceID.

The user subscription data management entity may generate the SliceIDₜ according to the SliceID through a preset generation rule.

In an embodiment, the user subscription data management entity sends the generated SliceIDₜ to the UE.

In addition, the user subscription data management entity also saves, updates and maintains a corresponding relationship list between SliceID and SliceIDₜ.

In the embodiments of the disclosure, by use of the SliceIDₜ, the condition that an attacker collects information of the UE accessing the network slice may be effectively avoided, and the privacy of the network slice identity information is protected.

Descriptions will be made below with application examples.

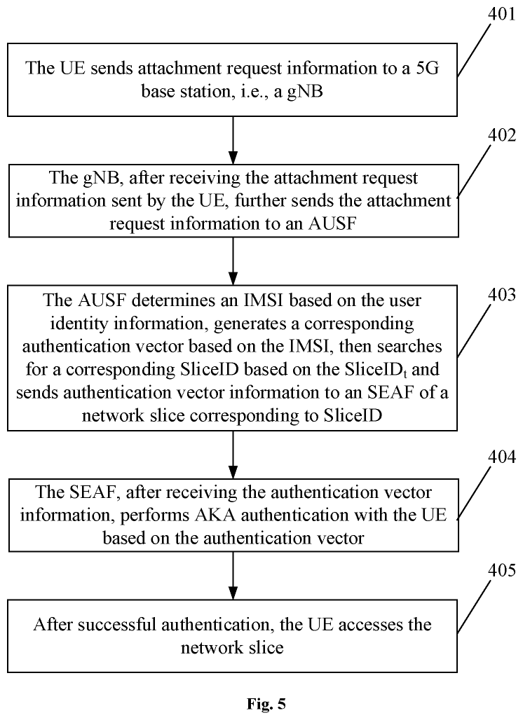

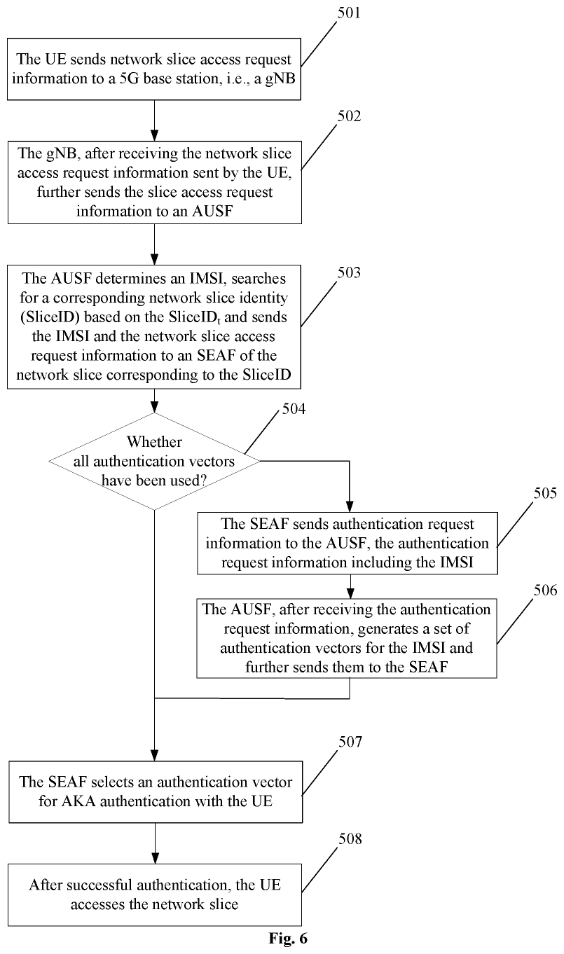

FIG. 5 is a flowchart of a network slice attachment procedure according to an application example of the disclosure. As shown in FIG. 5, an attachment flow of UE in the embodiment may include the following operations.

In operation 401, when UE is attached to a network, the UE sends attachment request information to a 5G base station, i.e., a gNB.

The attachment request information includes user identity information and SliceIDₜ. The user identity information may be temporary user subscription identity information such as a TMSI, and may also be encrypted user subscription identity information such as an SUCI.

In operation 402, the gNB, after receiving the attachment request information sent by the UE, further sends the attachment request information to an AUSF.

In operation 403, the AUSF, after receiving the attachment request information, determines user subscription identity information (IMSI) based on the user identity information, generates a corresponding authentication vector based on the IMSI, then searches for corresponding network slice identity information (SliceID) based on the SliceIDₜ and sends the authentication vector to an SEAF of a network slice corresponding to the network slice identity information (SliceID).

In operation 404, the SEAF, after receiving authentication vector information, performs AKA authentication with the UE based on the authentication vector.

In operation 405, after successful authentication, the UE accesses the network slice.

FIG. 6 is a flowchart of a network slice access procedure according to an embodiment of the disclosure. As shown in FIG. 6, an access flow of UE in the embodiment may include the following operations.

In operation 501, when the UE needs to re-access a network slice after being attached to a network, the UE sends network slice access request information to a 5G base station, i.e., a gNB.

The network slice access request information includes user identity information and SliceIDₜ. The user identity information may be temporary user subscription identity information such as a TMSI, and may also be encrypted user subscription identity information such as an SUCI.

In operation 502, the gNB, after receiving the network slice access request information sent by the UE, further sends the network slice access request information to an AUSF.

In operation 503, the AUSF, after receiving the network slice access request information, determines user subscription identity information (IMSI) according to user subscription related information, searches for corresponding network slice identity information (SliceID) based on the SliceIDₜ and then sends the user subscription identity information (IMSI) and the network slice access request information to an SEAF of the network slice corresponding to the network slice identity information (SliceID).

In operation 504, the SEAF, after receiving the IMSI and the network slice access request information, judges whether all authentication vectors in authentication vector information saved for the IMSI have been used or not, if all the authentication vectors have been used, operation 505 is executed, otherwise, operation 507 is executed.

In operation 505, the SEAF sends authentication request information to the AUSF, wherein the authentication request information includes the IMSI.

In operation 506, the AUSF, after receiving the authentication request information, generates a set of authentication vectors for the IMSI and further sends the set of generated authentication vectors to the SEAF.

In operation 507, the SEAF selects one authentication vector for AKA authentication with the UE.

In operation 508, after successful authentication, the UE accesses the network slice.

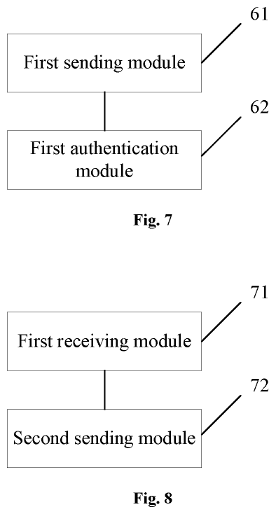

FIG. 7 is a schematic diagram of a device for accessing a network slice according to an embodiment of the disclosure. The device is applied to UE and includes:

a first sending module 61, configured to send request information for accessing a network slice, wherein the request information contains user identity information and temporary network slice identity information (SliceIDₜ); and

a first authentication module 62, configured to perform access authentication with the network slice and, in case of successful authentication, access the network slice.

The request information may be attachment request information, and may also be network slice access request information. The user identity information may be temporary user subscription identity information such as a TMSI, and may also be encrypted user subscription identity information such as an SUCI.

In an embodiment, the device further includes a first management module, configured to save and maintain a corresponding relationship list between SliceID and SliceIDₜ.

A piece of UE may access multiple different network slices, and in such case, a piece of UE may save, manage and maintain a corresponding relationship list between multiple pieces of different network slice identity information (SliceID) and corresponding temporary network slice identity information (SliceIDₜ).

FIG. 8 is a schematic diagram of a device for accessing a network slice according to an embodiment of the disclosure. The device is applied to a user subscription data management entity and includes:

a first receiving module 71, configured to receive, from UE through a base station, request information for accessing a network slice, wherein the request information contains user identity information and temporary network slice identity information (SliceIDₜ); and

a second sending module 72, configured to determine authentication information of the UE according to the user identity information, search for corresponding network slice identity information (SliceID) according to the SliceIDₜ and send the authentication information to a security management entity of the network slice corresponding to the SliceID to enable the security management entity to perform authentication with the UE to implement access of the UE to the network slice.

In an embodiment, the request information for accessing the network slice includes attachment request information. The second sending module 72 is configured to determine user subscription identity information according to the user identity information and generate a set of corresponding authentication vectors according to the user subscription identity information.

In an embodiment, the request information for accessing the network slice includes network slice access request information, and the authentication information includes user subscription identity information and the network slice access request information. The second sending module 72 is configured to determine the user subscription identity information according to the user identity information.

In an embodiment, the first receiving module 71 is further configured to receive authentication request information sent by the security management entity, wherein the authentication request information contains the user subscription identity information.

In the embodiment, the second sending module 72 is further configured to generate a set of authentication vectors according to the user subscription identity information and send the set of generated authentication vectors to the security management entity.

In an embodiment, the device further includes a second management module, configured to generate the SliceIDₜ corresponding to the SliceID.

In an embodiment, the first management module is further configured to save, update and maintain a corresponding relationship list between SliceID and SliceIDₜ.

The embodiments of the disclosure also provide a system for accessing a network slice, which includes UE, a base station, a user subscription data management entity and a security management entity, wherein

the UE is configured to send, to the base station, request information for accessing a network slice, wherein the request information contains user identity information and temporary network slice identity information (SliceIDₜ), perform access authentication with the security management entity and, in case of successful authentication, access the network slice;

the user subscription data management entity is configured to receive the request information from the UE through the base station, determine authentication information of the UE according to the user identity information contained in the request information, search for corresponding network slice identity information (SliceID) according to the SliceIDₜ and send the authentication information to the security management entity of the network slice corresponding to the SliceID; and

the security management entity is configured to perform access authentication with the UE according to the authentication information and, in case of successful authentication, allow the UE to access the network slice.

The embodiments of the disclosure also provide UE, which includes:

a processor;

a memory configured to store an instruction executable for the processor; and

a transmission device configured to perform information transmission and reception communication according to control of the processor,

wherein the processor is configured to execute the following operations of:

sending request information for accessing a network slice, wherein the request information contains user identity information and temporary network slice identity information (SliceIDₜ); and

performing access authentication with the network slice, and in case of successful authentication, accessing the network slice.

The embodiments of the disclosure also provide a user subscription data management entity, which includes:

a processor;

a memory configured to store an instruction executable for the processor; and

a transmission device configured to perform information transmission and reception communication according to control of the processor,

wherein the processor is configured to execute the following operations of:

receiving, from UE through a base station, request information for accessing a network slice, wherein the request information contains user identity information and temporary network slice identity information (SliceIDₜ); and

determining authentication information of the UE according to the user identity information, searching for corresponding network slice identity information (SliceID) according to the SliceIDₜ and sending the authentication information to a security management entity of the network slice corresponding to the SliceID to enable the security management entity to perform authentication with the UE to implement access of the UE to the network slice.

The embodiments of the disclosure also provide a computer-readable storage medium, which stores a computer-executable instruction, the computer-executable instruction being configured to execute the method for accessing a network slice.

In the embodiments, the storage medium may include, but not limited to, various medium capable of storing program codes such as a U disk, a Read-Only Memory (ROM), a Random Access Memory (RAM), a mobile hard disk, a magnetic disk or an optical disk.

It can be understood by those of ordinary skill in the art that all or some operations in the method disclosed above and functional modules/units in the system and the device may be implemented via software, firmware, hardware and proper combinations thereof. In a hardware implementation mode, division of the functional modules/units mentioned in the above descriptions does not always correspond to division of physical components. For example, a physical component may have multiple functions, or a function or operation may be cooperatively executed by a plurality of physical components. Some components or all components may be implemented in the form of software executed by a processor such as a digital signal processor or a microprocessor, or implemented in the form of hardware, or implemented in the form of integrated circuits such as application specific integrated circuits. Such software may be distributed in a computer-readable medium, and the computer-readable medium may include a computer storage medium (or a non-transitory medium) and a communication medium (or a temporary medium). As known to those of ordinary skill in the art, the term “computer storage medium” includes volatile, nonvolatile, removable and irremovable media implemented in any method or technology for storing information (for example, computer-readable instructions, data structures, program modules or other data). The computer storage medium includes, but not limited to, a RAM, a ROM, an Electrically Erasable Programmable ROM (EEPROM), a flash memory or another memory technology, a Compact Disc Read-Only Memory (CD-ROM), a Digital Video Disk (DVD) or another optical disk, a cassette, a magnetic tape, a disk memory or another magnetic storage device, or any other medium that may be configured to store expected information and may be accessed by a computer. In addition, it is known to those of ordinary skill in the art that a communication medium usually includes a computer-readable instruction, a data structure, a program module or other data in modulated data signals of, for example, a carrier or another transmission mechanism, and may include any information delivery medium.

1. A method for accessing a network slice, comprising:
sending, by User Equipment (UE), request information for accessing a network slice, wherein the request information contains user identity information and temporary network slice identity information (SliceIDₜ); and
by the UE, performing access authentication with the network slice, and in case of successful authentication, accessing the network slice.

2. The method as claimed in claim 1, wherein the request information for accessing the network slice comprises at least one of:
attachment request information, and network slice access request information.

3. The method as claimed in claim 1, wherein the user identity information comprises at least one of:
temporary user subscription identity information, and encrypted user subscription identity information.

4. The method as claimed in claim 1, further comprising:
saving and maintaining, by the UE, a corresponding relationship list between network slice identity information (SliceID) and the SliceIDₜ, wherein the SliceIDₜ is in one-to-one correspondence with the SliceID.

5. A method for accessing a network slice, comprising:
receiving, by a user subscription data management entity from User Equipment (UE) through a base station, request information for accessing a network slice, wherein the request information contains user identity information and temporary network slice identity information (SliceIDₜ); and
by the user subscription data management entity, determining authentication information of the UE according to the user identity information, searching for corresponding network slice identity information (SliceID) according to the SliceIDₜ and sending the authentication information to a security management entity of the network slice corresponding to the SliceID to enable the security management entity to perform authentication with the UE to implement access of the UE to the network slice.

6. The method as claimed in claim 5, wherein the request information for accessing the network slice comprises attachment request information, the authentication information comprises one or more authentication vectors, and determining, by the user subscription data management entity, the authentication information of the UE according to the user identity information comprises:
by the user subscription data management entity, determining user subscription identity information according to the user identity information, and generating a set of corresponding authentication vectors according to the user subscription identity information.

7. The method as claimed in claim 5, wherein the request information for accessing the network slice comprises network slice access request information, the authentication information comprises user subscription identity information and the network slice access request information, and determining, by the user subscription data management entity, the authentication information of the UE according to the user identity information comprises:
determining, by the user subscription data management entity, the user subscription identity information according to the user identity information.

8. The method as claimed in claim 7, after sending the authentication information to the security management entity of the network slice corresponding to the SliceID, further comprising:
receiving, by the user subscription data management entity, authentication request information sent by the security management entity, wherein the authentication request information contains the user subscription identity information; and
by the user subscription data management entity, generating a set of authentication vectors according to the user subscription identity information and sending the set of generated authentication vectors to the security management entity.

9. The method as claimed in claim 5, wherein the SliceIDₜ is in one-to-one correspondence with the SliceID, and before receiving, by the user subscription data management entity from the UE through the base station, the request information for accessing the network slice, the method further comprises:
generating, by the user subscription data management entity, the SliceIDₜ corresponding to the SliceID.

10. The method as claimed in claim 5, wherein the user identity information comprises at least one of:
temporary user subscription identity information, and encrypted user subscription identity information.

11. The method as claimed in claim 5, wherein
the user subscription data management entity comprises an Authentication Server Function (AUSF), and the security management entity comprises a Security Anchor Function (SEAF).

12. A method for accessing a network slice, comprising:
sending, by User Equipment (UE) to a base station, request information for accessing a network slice, wherein the request information contains user identity information and temporary network slice identity information (SliceIDₜ);
by a user subscription data management entity, receiving the request information from the UE through the base station, determining authentication information of the UE according to the user identity information contained in the request information, searching for corresponding network slice identity information (SliceID) according to the SliceIDₜ and sending the authentication information to a security management entity of the network slice corresponding to the SliceID; and
performing, by the security management entity, access authentication with the UE according to the authentication information, and in case of successful authentication, accessing, by the UE, the network slice.

13. (canceled)

14. (canceled)

15. (canceled)

16. User Equipment (UE), comprising:
a processor;
a memory configured to store an instruction executable for the processor; and
a transmission device configured to perform information transmission and reception communication according to control of the processor,
wherein the processor is configured to run the instruction stored in the memory to execute operations in the method as claimed in claim 1.

17. A user subscription data management entity, comprising:
a processor;
a memory configured to store an instruction executable for the processor; and
a transmission device configured to perform information transmission and reception communication according to control of the processor,
wherein the processor is configured to run the instruction stored in the memory to execute operations in the method as claimed in claim 5.

18. The method as claimed in claim 12, wherein the request information for accessing the network slice comprises attachment request information, the authentication information comprises one or more authentication vectors, and determining, by the user subscription data management entity, the authentication information of the UE according to the user identity information contained in the request information comprises:
by the user subscription data management entity, determining user subscription identity information according to the user identity information, and generating a set of corresponding authentication vectors according to the user subscription identity information.

19. The method as claimed in claim 12, wherein the request information for accessing the network slice comprises network slice access request information, the authentication information comprises user subscription identity information and the network slice access request information, and determining, by the user subscription data management entity, the authentication information of the UE according to the user identity information contained in the request information comprises:
determining, by the user subscription data management entity, the user subscription identity information according to the user identity information.

20. The method as claimed in claim 19, after sending the authentication information to the security management entity of the network slice corresponding to the SliceID, further comprising:
receiving, by the user subscription data management entity, authentication request information sent by the security management entity, wherein the authentication request information contains the user subscription identity information; and
by the user subscription data management entity, generating a set of authentication vectors according to the user subscription identity information and sending the set of generated authentication vectors to the security management entity.

21. The method as claimed in claim 12, wherein the SliceIDₜ is in one-to-one correspondence with the SliceID, and before receiving, by the user subscription data management entity, the request information from the UE through the base station, the method further comprises:
generating, by the user subscription data management entity, the SliceIDₜ corresponding to the SliceID.

22. The method as claimed in claim 12, wherein the user identity information comprises at least one of:
temporary user subscription identity information, and encrypted user subscription identity information.

23. The method as claimed in claim 12, wherein
the user subscription data management entity comprises an Authentication Server Function (AUSF), and the security management entity comprises a Security Anchor Function (SEAF).
